(19) United States
(12) Patent Application Publication
(10) Pub. No.: US 2023/0067308 A1
(43) Pub. Date: Mar. 2, 2023

(54) INTERNET BASED PLATFORM IMPLEMENTED WITH MACHINE LEARNING SOFTWARE TO PROVIDE OTHERWISE UNOBTAINABLE TRANSACTION BASED DATA AND PLATFORM OPERATIONS

(71) Applicant: YourCar YourChoice, LLC, Stafford, VA (US)

(72) Inventor: Oussama El Guennouni, Stafford, VA (US)

(21) Appl. No.: 17/412,155

(22) Filed: Aug. 25, 2021

(51) Int. Cl. G06Q 30/08; G06Q 30/06; G06Q 20/12; G06Q 30/02

(52) U.S. Cl. CPC G06Q 30/08; G06Q 30/0631; G06Q 30/0607; G06Q 30/0609; G06Q 30/0629; G06Q 20/12; G06Q 30/0206

(57) ABSTRACT

A processor-based platform enables users to input data regarding characteristics of a specified object relevant to value of the specified object; calculating three different price ranges for the specified object based on the input data; providing the user with three different choices for selling the object, the three choices including: a first choice for the user to complete sale of the specified object over a short period, the first choice providing the user with a generated low price range, a second choice for the user to complete sale of the specified object over a second period longer than the short period, the second choice providing the user with a generated medium price range, and a third choice for the user to complete sale of the specified object over a third period longer than the second period, the third choice providing the user with a generated high price range.

### BACKGROUND

Some embodiments are related to an online platform implemented with machine learning software to provide otherwise unobtainable transaction-based data and platform operations. Some of these embodiments are more specifically related to methods and apparatus for integrating and facilitating transactions involving goods and/or services.

### SUMMARY

Some embodiments relate to a methods and apparatus (system or platform) for integrating or facilitating transactions, including providing a multi-choice online system through which an entity can transfer, sell and/or purchase an object or service. In some embodiments, this system includes three choices, wherein each choice has a unique timeframe and method to sell and/or transfer, sell, or purchase the object or service. This may benefit the seller (or transferring party) by giving the seller (or transferring party) options to sell/transfer their object or service, with the options lessening existing time, monetary and efficiency costs present in related art systems. This may also benefit the buyer (or receiving party) of the object or service by giving the buyer (or receiving party) easier access to desired access to desired objects or services and providing the object or service at a favorable value. This also benefits the owner or operator of the method, system, or platform such as through fees or other compensation associated with the system operation.

In some embodiments, the object or service can be an automobile or truck. However, other vehicles can alternatively or additionally be transferred via the system, such as boats, jet-skis, snowmobiles, motorbikes, aircraft, bicycles, etc. However, it is intended for the system to be used to transfer any object or services that can possibly be transferred.

Some embodiments are directed to a processor-based platform usable with an external database and having at least one memory with an internal database and computer readable code stored thereon that enables a user of the platform to facilitate sale of a specified object. The internal database has data relating to sale of a plurality of internal objects via the platform. Some of the plurality of internal objects share characteristics similar to the specified object. The external database has data relating to sale of a plurality of external objects via the platform. Some of the plurality of external objects share characteristics similar to the specified object.

In some embodiments, the code enables steps that include: enabling a user to input data relevant to characteristics of the specified object that are relevant to value of the specified object; and calculating three different price ranges for the specified object based on the input data.

In some embodiments, the step of calculating includes: analyzing the internal database based on the input data to identify other similar internal objects that share similar characteristics to the specified object, storing as a first data set data relating to the identified similar internal objects including data relating to sale, market trends, seasonality, and geographic location, analyzing the external database based on the input data to identify other similar external objects that share similar characteristics to the specified object, storing as a second data set data relating to sale of the identified similar external objects, and utilizing the first and second data sets to generate three ranges of pricing relevant to the specified object, where the three ranges differ based on time dependent variables relating to length of time for completing sale of the specified object, such that shorter sales times provide relatively low price ranges compared to longer sales times, the three ranges include a low price range, a medium price range, and a high price range.

In some embodiments, the code enables steps that include: providing the user with three different choices for selling the object, the three choices including: a first choice for the user to complete sale of the specified object over a short period, the first choice providing the user with the generated low price range, a second choice for the user to complete sale of the specified object over a second period longer than the short period, the second choice providing the user with the generated medium price range, and a third choice for the user to complete sale of the specified object over a third period longer than the second period, the third choice providing the user with the generated high price range.

In some embodiments, the code enables steps that include enabling the user to select one of the three choices to thereby facilitate sale of the specified object.

Some embodiments include an internal auction application that enables a user to: list the specified object on an online auction, host the online auction by managing auction format, bidding functionality, auction pacing, and proxy bidding, electronically exchange currency between users upon termination of the online auction, and electronically exchange ownership rights of the specified object upon termination of the online auction.

In some embodiments, the internal auction application is hosted on a separate subsidiary platform separate from the at least one memory, the internal database, and the computer readable code stored thereon, to thereby enable uses to buy the specified object on the subsidiary platform, the subsidiary platform being able to communicate with the internal and external databases and the computer readable code stored thereon.

In some embodiments, the code enables steps further including prompting the user to purchase a new object different from the specified object via the internal auction application, identifying potential new objects based on characteristics of the specified object, and presenting the identified potential new objects to the user.

In some embodiments, the code enables steps further including prompting the user to purchase a new object different from the specified object, identifying potential new objects based on characteristics of the specified object, and presenting the identified potential new objects to the user.

In some embodiments, the specified object is a vehicle.

In some embodiments, the vehicle is at least one of an automobile or truck.

In some embodiments, vehicle is at least one of a boat, jet ski, and snowmobile.

In some embodiments, the medium price range is generated based on an estimation of bidding results of multiple commercial entities engaged in selling objects similar to the specified object.

In some embodiments, the commercial entities are entities that focus on selling automobiles.

In some embodiments, the first choice presented to the user enables the user to directly sell the specified object to a dealer for the low price range, and the system facilitates the transfer of the specified object to the dealer by facilitating scheduling appointments and exchanging sales documents.

In some embodiments, the code enables steps further including facilitating inspection of the specified object by a potential buyer and prompting the user with choice 2 if the potential buyer rejects the specified object based on the inspection.

In some embodiments, the second choice presented to the user enables the user to sell the specified object via auction of participating commercial entities engaged in selling objects similar to the specified object, and the system facilitates the transfer of the specified object by facilitating scheduling appointments and exchanging sales documents.

In some embodiments, the code enables steps further including prompting the user with alternative selling options if the specified object is not sold at the auction.

In some embodiments, the third choice presented to the user enables the user to sell the specified object via a commercial entity engaged in the business of selling objects similar to the specified object, wherein the sale to the commercial entity is completed upon the commercial entity receiving offers for the specified object from a third party.

### BRIEF DESCRIPTIONS OF DRAWINGS

Each figure connects sequentially as part of a larger logical process. Various exemplary aspects of the systems and methods will be described in detail, with reference to the following figures, wherein:

FIG. 1 is a flowchart denoting the questions presented to the entity selling a vehicle through the system and the choices of sale provided based on the questions.

FIG. 2 is a flowchart that is a continuation of FIG. 1 for the process and method of sale for choice one.

FIG. 3A and FIG. 3B is a flowchart that is a continuation of FIG. 1 and FIG. 2 for the process and method of sale for choice two.

FIG. 4 is a flowchart that is a continuation of FIG. 1, FIG. 2 and FIG. 3A and FIG. 3B for the process and method of sale for choice three.

### DETAILED DESCRIPTIONS OF DRAWINGS

### I—Alternatives

These and other features and advantages are described in, or are apparent from, the following detailed description of various exemplary embodiments.

It will be understood that when an element is referred to as being “connected,” or “coupled” to another element, it can be directly connected or coupled to the other element or intervening elements that may be present. In contrast, when an element is referred to as being “directly connected” or “directly coupled” to another element, there are no intervening elements present. As used herein “and/or” includes any and all combinations of one or more of the associated listing items. Further, it will be understood that when an element is “presented” to an entity, it can be presented electronically to the entity through multiple intermediaries or elements of the system. In addition, it will also be understood that when an element is referred to as being “directly presented” to an entity, it is presented electronically through only one intermediary or element of the system. In addition, it will be understood that when an element is presented or directly presented to an entity the presentation may take place on an electronic screen separate from any or all previous electronic screens.

It will be understood that, although the terms “first,” “second,” etc. may be used herein to describe various elements or components these elements or components should not be limited by these terms. These terms are only used to distinguish one element or component from another element or component. Thus, a first element or component discussed below could be termed a second element or component without departing from the teachings of exemplary embodiments. Further it will be understood that the use of “then,” when used to describe connecting two steps of a logical process, indicates that the steps may occur sequentially, but does not preclude the addition of intermediary steps or elimination of one of the steps without departing from the teachings of exemplary embodiments.

Exemplary embodiments are described herein with reference to logical process illustrations that are schematic illustrations of idealized embodiments (and intermediate structures) of exemplary embodiments. As such, variations from the sequence of the illustrations as a result, for exemplary, of inclusion of intermediary steps, are to be expected. Thus, exemplary embodiments should not be construed as limited to the particular sequence of logical steps illustrated herein but are to include deviations in the sequence of the steps, for exemplary, from communication of electronic information to remote databases. Thus, the logical steps illustrated in the figures are schematic in nature and their sequence is not intended to limit to scope of exemplary embodiments.

The terminology used herein is for the purpose of describing particular embodiments only and is not intended to be limiting of exemplary embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which exemplary embodiments belong. It will be further understood that all terms, such as those defined in commonly used dictionaries, should be interpreted as having a meaning that is consistent with their meaning in the context of the relevant art and will not be interpreted in an idealized or overly formal sense unless expressly so defined herein. As used herein, expressions such as “at least one of,” when preceding a list of elements, modify the entire list of elements and do not modify the individual elements of the list.

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain exemplary embodiments of the present description.

### II—Context and Alternatives

This invention pertains to a partially electronic system which can be used for the sale of automobiles, used automobiles, or other like items. A user of the system to sell an automobile (seller) benefits from the multiple-choice system described herein. Sellers benefit because they are given greater autonomy and control in the sale of their vehicle, thus providing monetary and efficiency benefits which are specific to each seller's specific needs and situation. A user of the system to buy an automobile (buyer) benefits because they are given a greater ability to acquire an automobile with specifications which meet their needs as well as acquiring the vehicle at a price preferable to current systems.

There are many steps involved with the sale of an automobile, especially with the sale of used automobiles. Typically, the seller of a used automobile has to physically travel to a dealership. While electronic tools do exist for the seller to obtain information regarding the approximate value of their vehicle, physical dealerships employ techniques to either exploit the seller's lack of knowledge in the industry or to “wear them down” with excessive wait times, negotiations etc. Thus, sellers of used cars often do not obtain a fair market price and are subjected to an inefficient and time-wasting processes. While online systems for the sale of used automobiles do exist, these systems generally use a “one size fits all” approach, which does not take into consideration a seller's particular needs. For buyers of used cars, the current system of sale is also inefficient. Dealerships are the most common buyers of used cars. However, if there is a particular vehicle specification that the dealership needs, the dealership must wait for a seller to physically come to the lot to acquire the vehicle. Furthermore, a seller might choose a dealership offering a lower price for the car without any knowledge of a secondary dealership which is willing to pay more for the car as a result the second dealership's current inventory. Dealerships do have the ability to electronically buy used cars, but often the transportation costs associated with the sale deduct heavily from the dealership's profit margins.

The present invention seeks to streamline this process by giving the sellers of used cars a set of options to sell their car. These options may include a buy-it-now feature where a third-party company acquires the used car and shops it around to dealerships. These options may also include a feature where the third-party charges the seller a fee and then finds the seller the best price for their vehicle by shopping it around for a set amount of time. These options may also include a higher fee and longer timeframe, but also provides the greatest sale price for the seller. This solves the aforementioned problems, as it is industry experts selling these cars who have professional relationships with dealerships.

### III—Exemplary Embodiment

A—Vehicle Entry into System

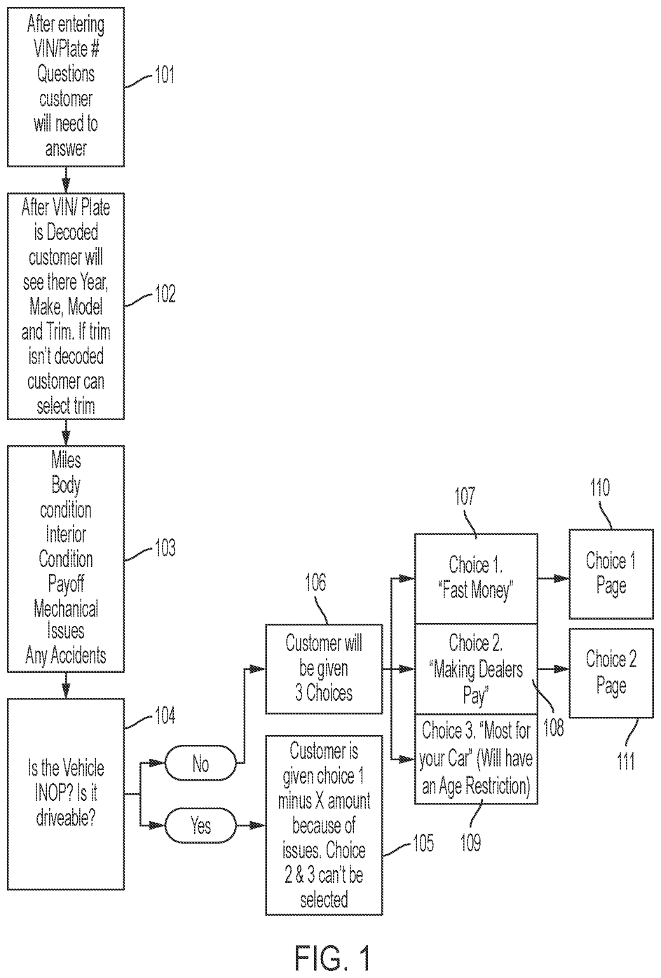

Turning now to FIG. 1, a flowchart showing the initial steps for a user to sell their vehicle is shown. Certain steps in the flowchart are presented electronically to the customer through a webpage, mobile app, or other electronic means. This process may or may not occur before a user has created an electronic user-specific account with the owning entity. The flowchart details the steps by which a vehicle is initially input into the inventive system by a combination of user input and backend system functionality. Any data retrieved by this method may or may not be used in conjunction with an external database system to store and utilize the information.

The customer will initially be presented with an electronic input box and be prompted to input the vehicle identification number (VIN) and license plate number. This is shown in FIG. 1. Point 101. The customer may also be presented with other questions which they will be prompted to answer.

Then, after this information has been entered, it will be decoded by the system. This is shown in FIG. 1. Point 102. The system may access external databases to retrieve information regarding the user's vehicle. This information may include the year, make, model and trim of the vehicle. Any information, such as trim, that was not decoded by accessing external databases, will trigger a prompt for the user to manually enter this information. Upon the system receiving this information, the information may be presented to the user. This presentation may include a visual presentation, such as an image of the vehicle type specified. Further, this presentation may include an animation of the vehicle type specified. The visual presentation information may be retrieved by the system from external sources or could be retrieved from the system's own databases.

Then, the user will be prompted to input vehicle specific information into the system. This is shown in FIG. 1. Point 103. This information may include vehicle mileage, the condition of the vehicle's body, the condition of the vehicle's interior, the financial information associated with the vehicle, mechanical issues with the vehicle, any accidents the vehicle has been involved in, and other similar questions. Upon receiving this information, the information may be stored in the system itself, or in external databases for other use. The system may prompt the user to input pictures of the vehicle. This prompt may be universal to all users, specific to certain users, or dependent upon any or all of the received information.

The system will then determine if the vehicle is inoperable. This is shown in FIG. 1. Point 104. This determination may be based on information retrieved from previous questions. Alternatively, this determination may be a result of prompting the user to manually input whether the vehicle is inoperable.

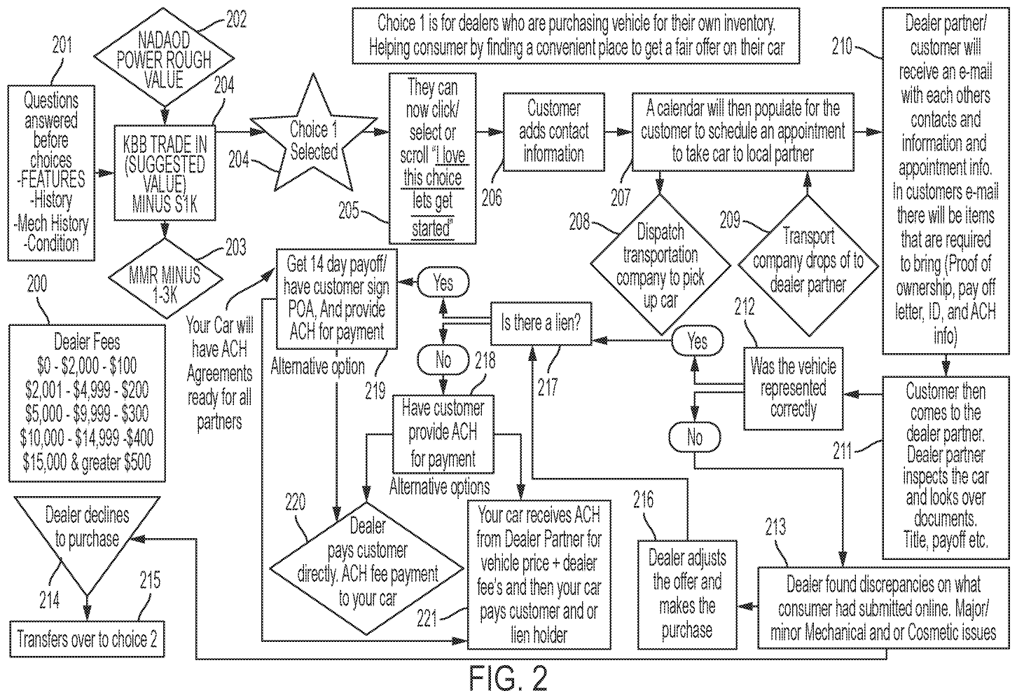

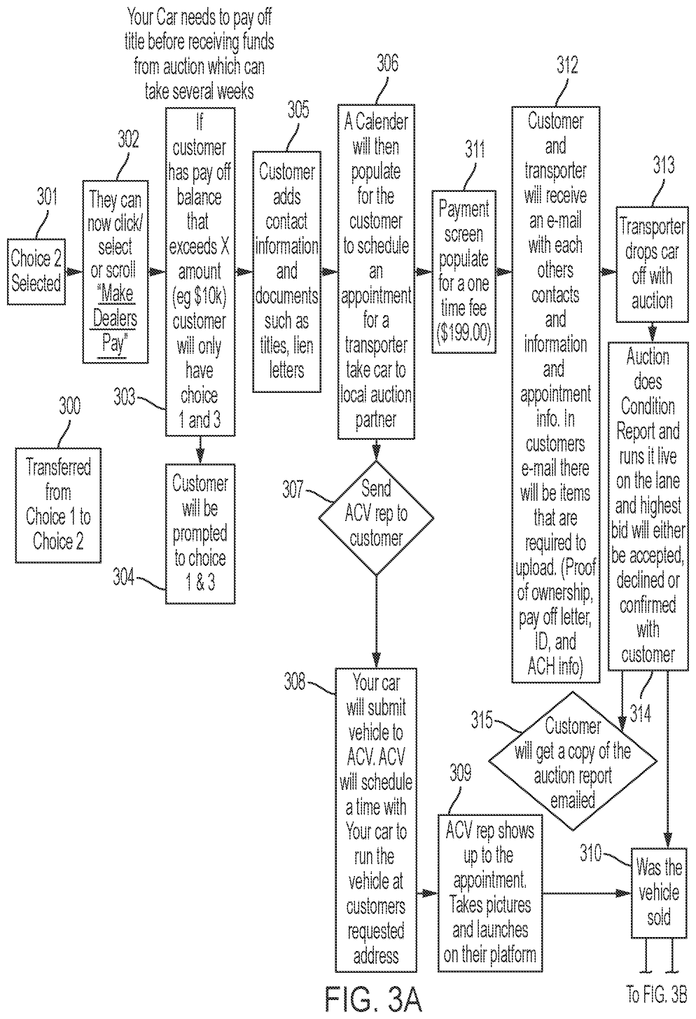

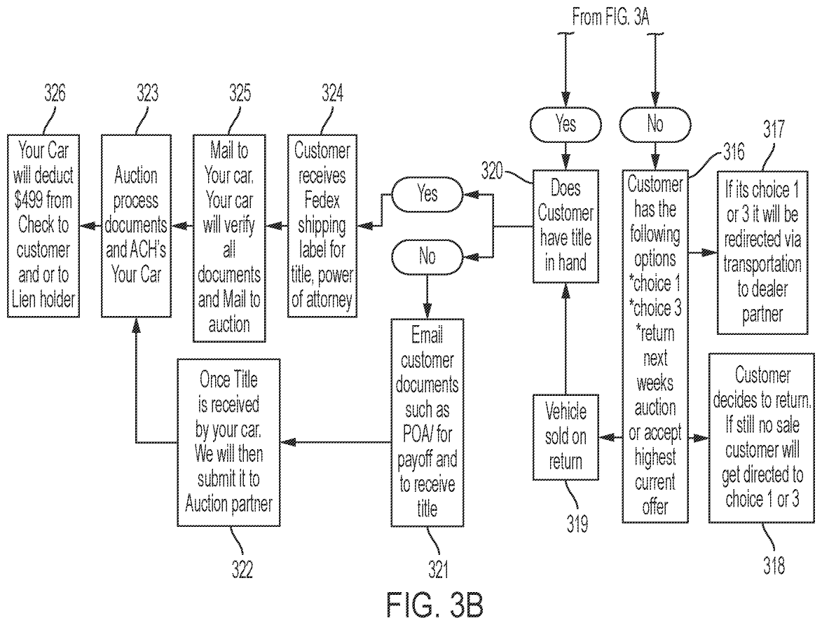

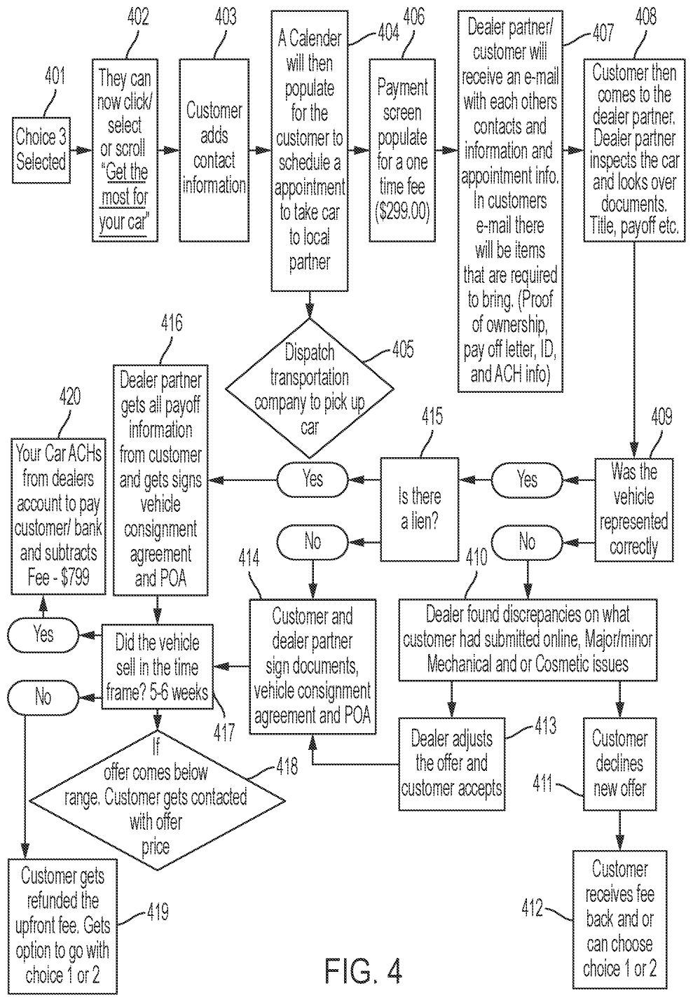

If the vehicle is determined to be inoperable, the user may only be presented with Choice 1 (FIG. 2). In this circumstance the user may not be able to access Choice 2 (FIG. 3A) and Choice 3 (FIG. 4) This is shown in FIG. 1. Point 105. The value offered in this case will be deducted by a determined amount based on issues with the car. The determination may be calculated through use of external databases. Alternatively, the determination may be calculated based on a set amount or percentage of value. Alternatively, the determination may be manually calculated by an administrator of the system. Alternatively, the determination may include the user being prompted for further information and using this information to calculate the deducted amount. Alternatively, this determination may be calculated by any combination of the aforementioned methods or another method entirely.

If the vehicle is determined to be operable, the user may then be presented with three choices. This is shown in FIG. 1. Point 106. Information regarding what each of these choices entail may be presented to the user at this time. In addition, an estimated predicted final sale value may be presented to the user at this time. The user may then select which choice they wish to pursue. This is shown in FIG. 1. Points 107-111.

B—Choice 1

Turning now to FIG. 2, a flowchart showing the steps taken in the Choice 1 aspect of the system is shown. In certain embodiments, Choice 1 may be referred to as the “Fast Money” option. Choice 1 may be presented to the user either by their selection after the system aspect described in Section III A or may be the only choice presented after the system aspect described in Section III A. This is shown in FIG. 2. Point 201. Choice 1 may also be reached under certain circumstances through Choice 2 or Choice 3. Choice 1 is intended to quickly provide the user the fastest sale of their vehicle, which may be for a price lower than the other two options. Choice 1 may take place on a different electronic screen than the system aspect described in Section III A.

Prior presenting the user with Choice 1, the value of the vehicle in question is determined. The determination of the value of the vehicle may utilize external databases and tools, such as ID Power, National Automobile Dealer Association (NADA), Kelley Bluebook (KBB), Manheim Market Report (MMR), and others. A certain amount will be deducted from the suggested values from the combination of calculations performed using the aforementioned resources. In certain embodiments this deduction may be between $1,000 and $3,000. In other embodiments this deduction may be a different amount. The final calculation for the price of the vehicle will be the “suggested amount.” This is shown in FIG. 2. Point 202-204.

Then, after the user selects Choice 1, the user is presented with the value of the “suggested amount”. The user will then be given a choice, wherein the user evaluates this value and decides whether to continue with this Choice. In certain embodiments, the user can select an option to continue. In certain embodiments, this option to continue may include the language “I love this choice let's get started.” This is shown in FIG. 2. Point 205. In certain embodiments, if the vehicle has been determined to be operable, the user is also presented with an option to return and choose Choice 2 or Choice 3 instead. This may then bring the user either to the previous screen or to a separate screen where they can select Choice 2 or Choice 3. The user may also be prompted to sell their vehicle via the internal auction application (described in Section IV).

Then, if the user selects the option to continue with Choice 1, the user will be presented with a prompt to input the user's contact information. This is shown in FIG. 2. Point 206. This information may include the user's address, email, telephone number, and other such information.

The user will then be presented with a calendar. This is shown in FIG. 2. Point 207. This calendar will be populated with appointments available at a local dealer partner for the vehicle to be inspected and sold. There may be a brief description of the local dealer presented to the user. The user will then select a time to meet with the local dealer. If the vehicle is inoperable, a transportation company may be contacted through the system to pick up the vehicle and drop it off at the dealer partner. This is shown in FIG. 2. Points 208-209. In certain embodiments, the user is able to schedule the vehicle pickup with a similar calendar presentation.

Then, when the appointment has been scheduled, the system will dispatch an email to both the user and the local dealer. This is shown in FIG. 2. Point 210. This email may contain the time and location of the appointment. The email to the user may also contain information regarding what is necessary to bring to the appointment such as the proof of ownership, a pay-off letter, identification, direct deposit information, and possibly other items. The email to the local dealer may include information regarding the offering price of the car. The email to the dealer may also include the vehicle specific information entered by the user when the user first input the vehicle specifications into the system.

Then, the customer and local dealer meet at the appointed time. This is shown in FIG. 2. Point 211. The dealer inspects the condition of the vehicle. The dealer also inspects the paperwork associated with the vehicle, such as the title, payment information etc. The dealer then decides if the vehicle was represented correctly. This is shown in FIG. 2. Point 212.

In the case that the dealer decides that the vehicle was represented correctly, then the dealer establishes if there is lien on the car. This is shown in FIG. 2. Point 217.

In the case that the dealer decides that the vehicle was not represented correctly, then the dealer establishes what aspect of the vehicle was represented incorrectly. This may include major/minor mechanical issues, major/minor cosmetic issues, or other such discrepancies between what the user entered into the system and the actual state of the vehicle. This is shown in FIG. 2. Point 213.

Once the dealer establishes incorrect representation of the vehicle, the dealer may then decline to purchase the vehicle. This is shown in FIG. 2. Point 214. If the vehicle is operable, the user may then be transferred to Choice 2 in the system. This is shown in FIG. 2. Point 215. If the vehicle is inoperable, the user may not be transferred to Choice 2. In this case, the user may be offered other options. The user may also be prompted to sell their vehicle via the internal auction application (described in Section IV).

Alternatively, once the dealer establishes that the vehicle was represented incorrectly, the dealer may adjust the price offered for the vehicle. This is shown in FIG. 2. Point 216. In the case that the user declines this new offer, the user may be transferred over to Choice 2 if the vehicle is operable. If the vehicle is inoperable, the user may be presented with alternative options. The user may also be prompted to sell their vehicle via the internal auction application (described in Section IV). In the case that the user accepts the dealer's adjusted offer, the system would reach Point 217 in FIG. 2.

Point 217 in FIG. 2 is a reference point for whether the vehicle in question has a lien. There are two paths in the system, one path for if the vehicle has a lien and a second path for if the vehicle does not have a lien.

In the path wherein the vehicle does not have a lien, the customer may provide Automated Clearing House (ACH) direct deposit information for payment. This is shown in FIG. 2. Point 218. This option may be unique to the path wherein the vehicle does not have a lien.

In the path wherein the vehicle has a lien, the system owner may have ACH agreements prepared for all partners in the transaction. This is shown in FIG. 2. Point 219. These agreements may be created automatically during the process described in Section III A. These agreements may also be created at another previous point in the system. In addition to having these agreements arranged, a 14-day payoff process may be established for the user to pay off the lien. This payoff process may be longer or shorter dependent on certain variables or embodiments. In addition to the payoff process, the user may be required to sign a payment on account (POA). These aforementioned steps may be unique to the path from point 1 where the vehicle has a lien.

There may be two other options provided in the path from Point 217, which may be reached regardless of whether or not the vehicle has lien.

The first such option may be that the dealer pays the user directly. This is shown in FIG. 2. Point 220. In addition, a fee payment from the user to the system owner may be required in the form of an ACH payment.

The second such option is that the dealer provides an ACH payment to the system owner. This payment may include the vehicle price plus the dealer's fees. This is shown in FIG. 2. Point 221. Exemplary dealer fees are included as Point 200 in FIG. 2. In this case the system owner would then pay both the user and/or the lien holder if applicable.

In the case that a successful sale has been made, the user may be prompted to buy a new vehicle via the internal auction application (described in Section IV).

C—Option 2

Turning now to FIG. 3A, a flowchart showing the steps taken in the Choice 2 aspect of the system is shown. In certain embodiments Choice 2 may be referred to as “Make Dealers Pay”. Choice 2 may be presented to the user either by user selection during the system aspect described in Section III A or may be reached under certain circumstances through Choice 1 or Choice 3. Choice 2 is intended to provide the user the sale of their vehicle at auction, which may be for a price higher than that afforded by Choice 1. This process may also take longer than Choice 1. Choice 2 may take place on a different electronic screen than the system aspect described in Section III A.

When a user is transferred to Choice 2, they may be presented with a screen which describes the process associated with Choice 2. This screen may also contain a prompt which the user can select to continue with this choice. This is shown in FIG. 3A. Point 302. Then the user may be brought to another screen to continue the process associated with Choice 2. This screen may also contain a prompt which the user can select to return to the previous screen, which may be the screen described in Section III A.

Then, if the user selects the prompt to continue with Choice 2, the user may then be brought to another screen regarding the title of the vehicle to be sold. This is shown in FIG. 3A. Point 303. Because in Choice 2, the vehicle may be sold at auction, the system owner needs to pay off the vehicle's title before receiving the funds from the auction. This process of paying off the title may take several weeks for the system owner. Thus, if the user has a certain amount to pay off the title, the user may be only allowed Choice 1 or Choice 3. This is shown in FIG. 3A. Point 304. The user may receive a prompt indicating this and directing the user to either choice. The user may also be prompted to sell their vehicle via the internal auction application (described in Section IV). The amount outstanding on the title to trigger this event may be based off a multitude of factors and be different for every customer or may be a uniform amount. In certain embodiments, this amount may also be determined during the system aspect described in Section III A. In this case, the user may not be able to select Choice 2 on the initial selection screen, and there may be an explanation presented as to why Choice 2 is unavailable.

Then, if the user continues with Choice 2, the user will be prompted to submit contact information and documents such as titles, lien letters, etc. This is shown in FIG. 3A. Point 305.

Then the user may be presented with a choice. This is indicated in Point 1 in FIG. 3A. The customer may select if they wish to sell their car at a partner owned physical auction site, or if the user wishes to have their vehicle listed on a partner owned online auction platform. In certain embodiments a “physical auction” may constitute a physical site where the vehicle stored and is auctioned online. In other embodiments, a “physical auction” may constitute an auction physically held in-person at a certain location. In certain embodiments, the user may not be presented with the choice of physical or online auction, and instead the system may automatically choose for the user. In this case, the system may consider geographical distances to both physical and online dealer partners, auction availability, and other variables to determine which auction (physical or online) will be used.

Then, dependent on which auction (physical or online) is selected, a calendar will then populate with dates for the user to schedule an appointment. This is shown in FIG. 3A. Point 306. In the case of a physical auction being selected, this appointment may be for a transporter to take the vehicle to the physical auction site. In the case of an online auction being selected, this appointment may be for an online auction partner to send a representative to the location of the user. The user may then select an appointment which suits the user's needs.

From Point 306 in FIG. 3A, there may be two paths for the system to follow. The first path is for an online auction. The second path is for a physical auction.

In the first path from Point 306, an online auction partner will be notified of the appointment chosen by the user. In certain embodiments, this online auction partner may be ACV Auctions (ACV). In other embodiments, this online auction partner may be a different entity. A representative of the online auction partner may then be provided the user's contact information so the online auction partner can reach out electronically. This is shown in FIG. 3A. Point 307.

Then, the system owner may submit the vehicle information obtained by the system aspect described in Section III A to the online auction partner. Then, at the appointment chosen by the user, the online auction partner may send a representative to the user's location. This is shown in FIG. 3A. Point 308. In certain embodiments, this appointment may not be chosen by the user, and may instead be chosen either by the online auction partner or by the system itself.

Then, at the appointment, a representative of the online auction partner may travel to the user's location and may take photographs of the vehicle to be sold. The online auction partner may then use these photographs to launch the auction of the vehicle on the online auction partner's platform. This is shown in FIG. 3A. Point 309.

Then, the system may arrive at Point 310 in FIG. 3A where it is determined whether the vehicle was sold at auction.

In the second path from Point 306 in FIG. 3 when a physical auction is selected, a payment screen may populate. This is shown in FIG. 3A. Point 311. This payment screen may prompt the user to pay a one-time fee to cover the transportation cost resultant of sending a transporter to take the vehicle to a physical auction site. In certain embodiments, this fee may be a flat rate of one hundred and ninety-nine dollars. In other embodiments, this fee may be a flat rate of a different amount. In other embodiments, this fee may be dynamically chosen by the system dependent on geographic, availability, and demand factors. This dynamic pricing may also include other factors.

Then, both the user and the transporter may receive an email. This is shown in FIG. 3A. Point 312. This email may contain information such as contact information, and appointment information. Unique to the email received by the user, information such as required items for the appointment may be included. There may also be a prompt for the user to upload photographs of these items into the system. The items may include proof of ownership, pay of letters, identification, ACH information, along with others.

Then, the transporter may pick up the vehicle at the scheduled appointment time. The transporter may then drop the car off at the site of the physical auction partner. This is shown in FIG. 3A. Point 312.

Then, the physical auction partner will complete a condition report on the vehicle. This is shown in FIG. 3A. Point 314. In certain embodiments, this report may then be matched against the information obtained by the system during the system aspect described in Section III A.

The physical auction partner may then run the car at their physical auction site. This is also shown in FIG. 3A. Point 314. In certain embodiments, the highest bid will be communicated with the user, who will then have the option to accept or deny the bid. Alternatively, the physical auction partner may accept, or decline, the highest bid on behalf on the user. In certain embodiments if the physical auction partner accepts or declines the bid on behalf of the user, the user may then get a copy of the auction report via email. This is shown in FIG. 3A. Point 315.

Then, the system may arrive at Point 2 in FIG. 3A where it is determined whether the vehicle was sold at auction.

At Point 310 in FIG. 3A, there are then two paths the system may take. The first path is dependent on whether the vehicle was sold at auction. The second path is dependent on whether the vehicle was not sold at auction.

In the first path, if the vehicle was sold at auction, the system will continue to Point 320 in FIG. 3B.

In the second path, if the vehicle was not sold at auction, the user may then be alerted to this fact. The user may then be prompted to select one of number of choices. These choices may include the user selling car the via Choice 1 or Choice 3, rerunning the vehicle at the next physical auction, or accepting the highest current outstanding offer received from the previous auction. This is shown in FIG. 3B. Point 316. The user may also be presented with other options. The user may also be prompted to sell their vehicle via the internal auction application (described in Section IV).

In the case that the user selects to pursue either Choice 1 or Choice 3 (described in Sections III B and D respectively), the user will be redirected to pursue either of these options. This is shown in FIG. 3B. Point 317. In certain embodiments, this redirection may include having transport arranged for the vehicle to be taken to a dealer partner.

In the case that the user selects to rerun the vehicle at the next physical auction and the vehicle is sold, the system may then reach Point 320 in FIG. 3B.

In the case that the customer decides to rerun the vehicle at the next physical auction and the vehicle is again not sold, the customer may get directed to pursue either Choice 1 or Choice 3 (described in Sections III B and D respectively), the user will be redirected to pursue either of these options. This is shown in FIG. 3B. Point 318. In certain embodiments, this redirection may include having transport arranged for the vehicle to be taken to a dealer partner. The user may also be prompted to sell their vehicle via the internal auction application (described in Section IV).

Point 320 in FIG. 3B represents a decision point where it is determined if the user has the title of their vehicle in hand. Point 320 is reached upon sale of the user's vehicle at auction. In certain embodiments this determination may take place during the system aspect described in Section III A. There are two paths the system may take from Point 320. In the first path, the user does not have the vehicle's title in hand. In the second path, the user does have the vehicle's title in hand.

In the first path, where the user does not have the vehicle's title in hand, the system owner may email the user documents in order to receive the title. This is shown in FIG. 3B. Point 321. These documents may include a payment on account (POA) for payoff, as well as other documents.

Then, the user may utilize these documents to acquire the vehicle's title. The user may then send the title to the system owner. Once the title is received by the system owner, it may then be submitted to the auction partner. This is shown in FIG. 3B. Point 322.

The auction partner may then process received documents and directs pays the system owner via an automated clearing house (ACH) payment the value of the vehicle received at auction. This is shown in FIG. 3B. Point 323. The system owner will then deduct a certain amount from this payment in the form of a fee. This is shown in FIG. 3B. Point 326. In certain embodiments, this amount may be four hundred and ninety-nine dollars. In other embodiments, this amount may be a flat rate of a different amount or may be dynamically determined based on a variety of factors. The remaining amount of the transferred money less the deducted fee may then be transferred to the user or may be divided between the user and lien holder if applicable.

In the second path from Point 320, wherein the user has the vehicle's title in hand, the user may receive, from the system owner, a FedEx (or other applicable mailing service) label. This is shown in FIG. 3B. Point 324. The user may then use this label to mail necessary documents to the system owner. These documents may include the vehicle's title, power of attorney, and other necessary documents.

Then, once the system owner has received the documents, the system owner may verify the documents' accuracy and authenticity. Then the system owner will mail the documents to the auction partner. This is shown in FIG. 3B. Point 325.

The auction partner may then process received documents and directs pays the system owner via an automated clearing house (ACH) payment the value of the vehicle received at auction. This is shown in FIG. 3B. Point 323. The system owner will then deduct a certain amount from this payment in the form of a fee. This is shown in FIG. 3B. Point 326. In certain embodiments, this amount may be four hundred and ninety-nine dollars. In other embodiments, this amount may be a flat rate of a different amount or may be dynamically determined based on a variety of factors. The remaining amount of the transferred money less the deducted fee may then be transferred to the user or may divided between the user and lien holder if applicable.

In the case that a successful sale has been made, the user may be prompted to buy a new vehicle via the internal auction application (described in Section IV).

D—Choice 3

Turning now to FIG. 4, a flowchart showing the steps taken in the Choice 3 aspect of the system is shown. In certain embodiments Choice 3 may be referred to as “Get the most for your car”. Choice 3 may be presented to the user either by user selection during the system aspect described in Section III A or may be reached under certain circumstances through Choice 1 or Choice 2. Choice 3 is intended to provide the user the sale of their vehicle through consignment at a local dealer, which may be for a price higher than that afforded by Choice 2. This process may also take longer than Choice 2. Choice 3 may take place on a different electronic screen than the system aspect described in Section III A.

When a user is transferred to Choice 3, they may be presented with a screen which describes the process associated with Choice 3. This is shown in FIG. 4. Point 402. This screen may also contain a prompt which the user can select to continue with this choice. In certain embodiments this prompt may use the phrase “Get the most for your car.” Then the user may be brought to another screen to continue the process associated with Choice 3. This screen may also contain a prompt which the user can select to return to the previous screen, which may be the screen associated with the description in Section III A.

Then, the user is prompted to input contact information into the system. This is shown in FIG. 4. Point 403. This contact information may contain the user's address, telephone number, email address etc. In certain embodiments, this contact information may be obtained in a previous step in the system, such as the system aspect described in Section III A. At this point, a consignment offer for the vehicle's value may be provided to the user. This offer may be in the form of a range of values. In certain embodiments, this consignment offer may be provided at a previous step in the system.

Then, a calendar may populate with available appointments for the user to take the vehicle to a local partner. This is shown in FIG. 4. Point 404. The user may select the appointment which suits their needs. In certain embodiments, the user may also be prompted with the option to have a transportation company take the vehicle to the local dealer. This is shown in FIG. 4. Point 405. In this case, the user may be charged an extra fee. Additionally in this case, the user will have to select an appointment to meet the dealer partner.

Then, when the user has been an appointment with the dealer partner, a payment screen with populate prompting the user to pay a one-time fee. This is shown in FIG. 4. Point 406. In certain embodiments this fee may be two hundred and ninety-nine dollars. In other embodiments, this fee may be a flat rate of a different amount or may be dynamically calculated by the system based on a multitude of factors.

Then, after the user has paid the fee, both the dealer partner and the user may receive an email. This is shown in FIG. 4. Point 407. This email could contain the contact information of the dealer partner or the user, along with appointment information. The email to the user may contain details about the appointment, which may include a list of items to bring such as proof of vehicle ownership, pay off letters, ID, ACH information, and possibly other items.

Then, the user and dealer partner meet at the set appointment time. This is shown in FIG. 4. Point 408. This may take place at the dealer's place of business. The dealer may inspect the condition of the vehicle, as well as inspect the items the user was instructed to bring. Previous to this appointment, the dealer may have been provided by the system the vehicle information input by the user during the system aspect described in Section III A. The dealer may compare the information, with the dealer's own inspection of the vehicle and associated paperwork.

Then, the system will reach Point 409 in FIG. 4, which regards whether the vehicle was represented correctly. This may be based on the dealer's inspection of the vehicle. There may be two possible paths for the system to take at this point. The first path may be taken if the dealer discovers that the vehicle was represented incorrectly by the user. The second path may be taken if the dealer decides that the vehicle was represented correctly.

In the first path from Point 409, wherein the vehicle was represented incorrectly, the dealer may cite minor discrepancies between the actual condition of the vehicle and how it was initially input into the system. This is shown in FIG. 4. Point 410. Such discrepancies may include major/minor cosmetic issues, major/minor mechanical issues, and other such issues. The dealer may then adjust the consignment offer which had been provided to the user during one of the previous steps in the system.

In the case the user declines the dealer's new offer, the user may then receive back the previously paid one-time fee. The user may then be prompted to choose either Choice 1 or Choice 2 (described in Sections III B and C respectively). This is shown in FIG. 4. Points 411-412. The user may also be prompted to sell their vehicle via the internal auction application (described in Section IV).

In the case that the user accepts the dealer's new offer, the user and dealer may sign documents. The documents may include a consignment agreement, a payment on account (POA) agreement, as well as other such documents. This is shown in FIG. 4. Point 413-414. The system may then proceed to Point 417 in FIG. 4.

In the second path from Point 409 in FIG. 4, wherein the vehicle was determined to be represented correctly, it may be then determined if the vehicle has a lien. This is shown in FIG. 4. Point 415.

In the case that the vehicle does not have a lien, the user and dealer may sign documents. The documents may include a consignment agreement, a payment on account (POA) agreement, as well as other such documents. This is shown in FIG. 4. Point 414. The system may then proceed to Point 417 in FIG. 4.

In the case that the vehicle does have a lien, the dealer partner may obtain all payoff information from the user. This is shown in FIG. 4. Point 416. The dealer partner in addition may have the user sign a consignment agreement, a payment on account (POA) agreement, as well as other such documents. The system may then proceed to Point 417 in FIG. 4.

Point 417 in FIG. 4 represents whether the vehicle was sold by the dealer within a certain timeframe. In certain embodiments, this timeframe may be five to six weeks. In other embodiments, this timeframe may be of another flat amount, or dynamically determined by the system based on a multitude of factors.

In certain embodiments, if the dealer receives an offer on the vehicle within the timeframe, and this offer is below the range agreed on by the user and dealer in the consignment agreement, the user may be contacted. The user may accept or deny this offer. This is shown in FIG. 4. Point 418.

In the case that the vehicle was sold within the set timeframe and within the consignment offer value range, the system owner may be directly deposited the sale amount by the dealer. This is shown in FIG. 4. Point 420. In certain embodiments, the system owner may be directly deposited the sale amount, less the dealer's fees. With the amount the system owner receives from the dealer, the system owner may pay the user, and (in the case of a lien on the vehicle) pay the bank a portion of the amount. The system owner may also subtract and keep a fee from the received amount. In certain embodiments, this fee may be seven hundred and ninety-nine dollars. In other embodiments, this fee may be a different flat amount, or may be dynamically determined by the system based on a multitude of factors.

In the case that the vehicle was not sold within the set timeframe, the user may be refunded their upfront fee. This is shown in FIG. 4. Point 419. The user may then be prompted to choose either Choice 1 or Choice 2 (described in Sections III B and C respectively). The user may also be prompted to sell their vehicle via the internal auction application (described in Section IV).

In the case that a successful sale has been made, the user may be prompted to buy a new vehicle via the internal auction application (described in Section IV).

### IV—Internal Auction Application

A—General Auction Application Embodiments

Turning now to other exemplary embodiments of the system, the system may contain an internal auction application. In these embodiments, this internal auction application may be used in the place of the online auction partner referenced in Section III C.

Further, this internal auction application may be used as an additional choice to Choices 1, 2, and 3, wherein the user can select the auction application directly instead of one of the aforementioned choices.

Further, this internal auction application may be utilized by both users selling vehicles and users bidding on vehicles through the internal auction application. The internal auction application may be in the form of a different electronic medium based on the type of user. For example, sellers of vehicles may use a different application than bidders.

B—Administrative Functions

Continuing from Section IV A, exemplary embodiments of the system with an internal auction application may include administrative functions.

In exemplary embodiments, the internal auction application may include a delay function to manage the pace of the auction. This delay may be in the form of the auction application not accepting bids for a certain amount of time. This amount of time might be dynamically determined by the auction application based on analysis of historical auction data, artificial intelligence, auction prediction algorithms, and other data analysis.

In exemplary embodiments, the internal auction application may include an animation system which displays the item for sale and allows the user to virtually interact with and receive information regarding certain aspects of the item (i.e. clicking the engine of an animated, rotating car will display information regarding the engine). Clicking on certain parts of the animated vehicle may also display to the user photographs of the vehicle for sale. The animated vehicle animation may come from an external source and may be automatically pulled from said source by the auction application when a new auction template is created.

In exemplary embodiments, the auction application may discriminate between multiple kinds of users (i.e., consumers and car dealerships) and may provide different administrative and auction functionality to different kinds of users.

In exemplary embodiments, the auction application may include a multi-paned user interface which not only is interactive, but also displays in a separate pane, a summary of a user's current bidding (i.e., number of bids placed, how many auctions in which they are the highest bidder, total amount of money outstanding in placed bids etc. which automatically updates as the auctions go on). Further, this information may be communicated to an AI based administrative system. Further, the auction application may then communicate fixed price offers based on certain criteria (i.e., offering two reduced fixed price offers to the user based on the auctions the user is participating in, which are contingent on the user buying both cars).

In other embodiments, the internal auction application may include a method to implement reward points from a customer affinity program into the online auction application. The minimum opening bid price for the auction may be set in reward points and further, these reward points may be received as a bid by a bidder in the auction. This integration of customer reward points into an online auction is useful because customer rewards programs build customer excitement and help to develop and maintain customer loyalty.

In other embodiments, the internal auction application may include an animation system. These embodiments may include an animated auctioneer character which announces when certain bidding rounds have ended, along with a second animated character that acts as a bid spotter to solicit bids after the auctioneer makes this announcement. This is intended to solve a problem in timed online auctions wherein most bids are received at the very end, leading to processing issues and market price mismatches.

In other embodiments, the internal auction application may include functionality wherein time-related information is attached to both the bids themselves along with the price. The system may compare the time information attached to the bid against the time information attached to the price to determine whether or not the price has changed during the time the bid is processed and thus whether or not to accept the bid. This is helpful because it allows online auctions to function more fluidly and ensures that no errors occur wherein a lower bid is accepted due to bid processing time.

In other embodiments, the internal auction application may include functionality wherein bidder users of the online auction application are able to search the auction application and receive updates on auctions they are interested in. The bidder user provides a restriction request based upon restriction factors on the online auction service and based on these factors receives continually updated auction feeds on only the auctions returned by the restriction request. This allows for users to find items more easily they are most interested in and provides them information continuously on these auctions.

In other embodiments, the internal auction application may include functionality wherein an administrative “note” pertaining to a user or item is generated for use by administrators of the auction to better administrate the auction. This note may contain 1: administrative information and 2: note type information identifying the note as the first type in a predetermined set of notes. This is preferable to previous administration of online auctions as it allows information to better and more easily shared between administrators relative to alternatives i.e. email.

In other embodiments, the internal auction application may include functionality wherein GPS is used in conjunction with the online auction, so bidders can see where auction items are located geographically. This functionality may include the buyer receiving an auction item identifier from the GPS apparatus. This GPS based format allows bidders in online auctions to buy goods if geographical location is important more effectively to their buying decision.

In other embodiments, the internal auction application may include functionality wherein an external database is utilized through which performance bonds (to guarantee payment upon completion of the auction) are granted. An image may be displayed (i.e. seal) on the auction site to indicate that this bond or guarantee coverage is in effect for the auction transaction. This image may be under the exclusive control of the server hosting the online auction. This eliminates the default payment risk of buying or selling on the auction site, and is a preferable alternative to electronic escrow services, or other payment services such as PayPal which require more transactional costs in terms of time and money. Further, the internal auction application may include functionality wherein the level of the guarantee is displayed, may be determined on historical data from a participant of an online auction. This allows sellers to discriminate between bidders based upon the level of guarantee, this level indicating the likelihood of fraud on the part of the bidder, amongst other information on the bidder relevant to the seller.

In other embodiments, the internal auction application may include functionality wherein bidders' private information from previous bids is utilized to calculate a risk profile for the bidder and a report on this risk profile may be generated in order to provide the buyer and seller with information to make more informed auction decisions.

In other embodiments, the internal auction application may incorporate functionality which includes an interface which can pull auctions from either one online auction host or multiple different online auction hosts. This user interface may utilize a multi-auction display user interface for display of live video feeds from multiple auctions within different panes of the interface. The interface also may also respond to user signals to select auctions within this interface and adjusts framerates for the selected video feeds in order to accommodate bandwidth requirements. This functionality may be embodied as a screen divided into panes, where each pane is a video feed of an online auction, and the bidder can participate in each auction within said panes. This is useful because it more easily allows bidders to participate within multiple auctions simultaneously, thus potentially providing more revenue to the seller if said auctions are all from the same auction host. It also allows easier access for the bidder to multiple auction hosts.

In other embodiments, the internal auction application may incorporate functionality wherein an animated auctioneer is utilized to solicit and manage bidding. The functionality may provide an auction backdrop to showcase the auction item by a simulated representation of an auctioneer. Further, the functionality may be capable of conducting the auction with the simulated representation of an auctioneer soliciting bids from users, wherein this solicitation includes the simulation speaking dialogue to users. This is useful because this simulation may cause higher bidding during the auction.

In other embodiments, the internal auction application may incorporate functionality which includes the generation of an identification (ID) code of a bidder when they request information pertaining to an online auction item. The functionality then may use this ID code to remotely notify the bidder when the price changes by having the bidder download an updated information image generated by the network server. This improves on existing online auction methods by removing an information acquisition operation by the bidder, allowing them to monitor the auction more easily.

In other embodiments, the internal auction application may incorporate functionality which includes remote viewing of simultaneous live auctions through multiple windows so as to allow a single bidder to simultaneously participate in a plurality of auctions. The functionally may display both active and docked (deprioritized) windows based on user input. The level of information in a docked window, while still viewable, may be a subset of the more complete auction information in an active window. This is advantageous because it allows for a bidder to simultaneously participate in multiple auctions while being presented with information which is most pertinent at any given time in the auction process without being inundated with less useful information.

In other embodiments, the internal auction application may incorporate functionality which includes maintaining electronic payment accounts contained within an electronic auction payment system which itself is integrated with the auction application. The functionality may also receive permission prior to an auction to automatically transfer funds from buyer to seller and, if permission is received, execute this automatic transfer. This would address the issue where winning bidders take a long time to pay, inconveniencing the seller.

C—Auction Extensions, Reserve Pricing, and Proxy Bidding

Continuing from Section IV A, exemplary embodiments of the system with an internal auction application may include auction extension, reserve pricing and proxy bidding functionality.

In exemplary embodiments, the internal auction application may incorporate functionality wherein during the auction process, establishes a high fixed price, communicates this price to the highest bidder as an offer, and communicates to all other bidders that an offer of this amount was extended, which would incentivize further bidding.

In exemplary embodiments, the internal auction application may incorporate functionality wherein the auction application discriminates amongst specific bidders based on historical actions and determines whether or not they are allowed to place proxy bids, or what the minimum difference between the reserve price and the proxy bid is allowed to be.

In exemplary embodiments, the internal auction application may incorporate functionality wherein the auction application eliminates proxy bidding if the bidding pattern of the auction meets certain historic analytical thresholds.

In exemplary embodiments, the internal auction application may incorporate functionality wherein the auction application automatically raises the price of the auction to the highest proxy bid (possibly less a certain amount) and then prevents the bidder with the highest proxy bid from bidding for a certain amount of time in order to incentivize further bidding prior to the end of auction bidding rush.

In exemplary embodiments, the internal auction application may incorporate functionality wherein the auction application monitors how many individuals are currently engaged in the auction (i.e. monitoring it rather than based on bids alone) and dynamically extends the auction based on analytical data of the auction itself, rather than determining extensions prior to auction start.

In other embodiments, the internal auction application may incorporate functionality which includes allowing the seller a predetermined number of extensions which automatically extend the auction if a pre-determined reserve price is not met. This makes online auctions more efficient, as prior, an auction would be more likely to end without the reserve price being met. This would inconvenience the seller because they would have to set up a new auction.

In other embodiments, the internal auction application may incorporate functionality which includes determining that a high proxy bid for an item at auction is less than the auction item's reserve price, with the high proxy bid being the highest of all proxy bids for the item. The system may then automatically publish this information including the price of the highest proxy bid. This is useful because it informs a seller when their reserve price is too high for the level of demand, which prevents auctions from expiring without a winner.

In other embodiments, the internal auction application may incorporate functionality which includes providing fixed price purchase option which may be responsive to whether a particular buyer has placed a bid. This functionality can be used in a number of ways, for example, removing the fixed price option for a bidder as soon as a bid has been received from the bidder. This gives more options to the seller in an online auction related to how they wish to facilitate the auction of their particular item.

In other embodiments, the internal auction application may incorporate functionality which includes proxy bidding wherein a buyer selects a maximum price they are willing the bid and the auction system automatically submits a higher bid up to the maximum proxy price when this bidder is outbid. In addition, this functionality may include a user-selected time delay in their proxy bid system to maintain the pace of auction. The functionality may automatically check the plurality of submitted bids with the bids being separated in in time to form a pace of auction, determine that proxy bidding conditions (which include a time delay) have been met, and place a proxy bid based on both the proxy bid delay and a system wide counter bid delay. This is useful because it prevents two bidders with high proxies from automatically bidding up to a high maximum price, which is irritating to other bidders. It is also useful because maintaining the pace of the auction provides a better experience to bidders, making them more likely to bid in future auctions.

In other embodiments, the internal auction application may incorporate functionality which includes setting a fixed price to buy an item based upon criterion established by the bidding of an item in an online auction. This functionality may include a fixed price setting process wherein a fixed price is established responsive to bids reaching a certain value during the auction. This may be an automatic function executed from computer memory. This is advantageous because in many online auctions only one bid would be received and the bidder would have to wait an extended time for the auction to end, and also because sellers often set an artificially high reserve price which is higher than any bidder is willing to pay.

In other embodiments, the internal auction application may incorporate functionality which includes an online auction format which is distinct from an ascending bid format. This functionality may pertain to an online auction containing multiple types of items, with each type including plural items. Bids may be received from a plurality of bidders, the functionality may determine if the auction should continue, and if it should, communicates a revised price vector back to the bidders based on the received bids. This is a more efficient method auctioning items with complex possibilities for substitution than other online auction formats.

In other embodiments, the internal auction application may include functionality wherein the end time for an auction system can be automatically extended. This functionality may include a process where, prior to an auction, a minimum bid threshold (MBT) is established which represents the number of bids that must be received within a predetermined timeframe at the auction end time in order to automatically extend the auction. The functionality may implement the auction with these parameters, along with the total number of extensions allowed. This is beneficial as it prevents auctions from being prematurely cut off, allowing for increased revenue for the seller.

In other embodiments, the internal auction application may include functionality wherein proxy bids are used. Proxy bids are bids that do not specify a specific bid amount, but rather a ceiling price which the bidder is willing to pay. The functionality may sort the proxy bids by bid limit and use this set for calculations. The auction application may determine the highest losing proxy bid, and in the case that the winning proxy bidder declines the allocated goods, increments the second highest bidding proxy by a predetermined increment in order to assign this buyer as the winner of the auction. This is more efficient and uses less processing power than other systems which constantly compare bids.

D—Bidding Functionality

Continuing from Section IV A, exemplary embodiments of the system with an internal auction application may include bidding functionality.

In exemplary embodiments, the internal auction application may incorporate functionality wherein only a subset of bidders is allowed to provide short bids on items based on a ranking threshold predetermined by previous bidder performance.

In exemplary embodiments, the internal auction application may incorporate functionality wherein bid increments are determined by item type, auction value, and analytical historical bidding patterns of like items.

In exemplary embodiments, the internal auction application may incorporate functionality wherein the auction application monitors whether a bidder is participating in several auctions simultaneously, and when this bidder places a bid on a particular item, allowing them to retract current winning bids in other auctions. In addition, the user may only do this a dynamically determined amount of times, or when the other auctions are nearing close. When this occurs, the auction application may communicate to bidders in the auctions where the winning bid has been retracted that the price has gone down, which would incentivize further bidding.

In other embodiments, the internal auction application may include functionality wherein the bidder is allowed to buy one or more units at fixed price while the bidder has outstanding bids in the auction and reducing the number of bids outstanding by the number of units purchased at the fixed price. Essentially, if many items of the same type are for sale in an online auction with a fixed price and bidding function, the bidder can bid for 10 units, choose then to buy 5 at the fixed price, and automatically have their 10 bids reduced to 5.

In other embodiments, the internal auction application may include functionality wherein bidders are prompted to place a bid by selecting from a plurality of predetermined bid increments. These predetermined bid increments may be changed during a revision event, this revision event being related to the passage of a certain period of time during which no bids are placed. This is useful as it induces bidders to bid in higher amounts, rather than just increasing the winning bid by a small amount, and thus provides more revenue to the seller. It is also useful because revision events changing the bid increments allows the auction to automatically adapt to a diverse set of auction conditions.

In other embodiments, the internal auction application may include functionality wherein bids below the current or reserve price (short bids) can be received. This functionality may allow for bids to be received by the seller regardless of the asking price or any other bid prices, and in the case where a short bid is received by the seller, giving the seller the ability to sell at this short-bid price to the bidder. This gives more flexibility to the seller, as they are not locked into their initial reserve price and can accept a short bid at any time (especially when no bids are placed higher than the initial price).

E—Seller Functionality

Continuing from Section IV A, exemplary embodiments of the system with an internal auction application may include seller functionality.

In exemplary embodiments, the internal auction application may incorporate functionality for selecting the optimal auction method based on historical and analytical data, which is a part of the auction application itself, rather than being owned by a third party. Further, the functional may include pulling data from other websites (Carfax for example) to provide the seller prior to auction a list of probable vehicle values. The seller may be able to use this list of probable values to determine auction functionality either prior to auction, or as the auction is ongoing.

In exemplary embodiments, the internal auction application may incorporate functionality which includes a tracker of an auction which, as the auction is ongoing, allows the seller (or system administrator) to monitor the deviation said auction has from historical auctions of a similar type.

In exemplary embodiments, the internal auction application may incorporate functionality which includes providing the seller a list of all bidders who have participated in the auction with analytical information regarding previous performance in other auctions, user activity (how many auctions each bidder has participated in) and may use data analysis from the user's previous auctions to estimate a budget threshold for each bidder. Further, the functionality may analyze the deviation each bidder has in their participation amongst items of different types and communicating this to the seller (i.e., this bidder buys Hondas 90% of the time while another bidder buys Hondas 10% of the time)

In other embodiments, the internal auction application may include functionality wherein the internal auction application analyzes an online auction host or seller to determine strategies and best practices to maximize profits. This may be in the form of an analysis tool which can be used to figure out how best to market and auction specific items. This functionality may include a secure portal interface for allowing a third party to provide a description and target price for items to be sold. This may be in combination with an auction strategist module which automatically selects an auction strategy to be used, based on analytical information.

In other embodiments, the internal auction application may include functionality to advertise to bidders, auctions which they would be likely to participate in. This functionality may include a method which identifies users who have not bid in a particular auction who have bidding histories which substantially match those of bidders who have already participated in said auction. This is useful because when this information is used to advertised to the identified bidders likely interested in the auction, it will increase the total amount of bidders in the auction.

In other embodiments, the internal auction application may include functionality to allow the network-based authorization of a bidder to bid on an item and the automatic communication of this authorization, allowing the bidder to bid. This may allow a seller to determine who is allowed to bid on their item at auction and automatically communicates this authorization, allowing the bidder to bid. This is helpful in online auctions as it limits the number of “bogus” bids and provides the seller with increased confidence that specific sellers are sincerely bidding.

In other embodiments, the internal auction application may include functionality which provides the seller in the auction graphical information regarding the current status of bidding. This may include the generation of a graphical presentation of auction status comprising a first and second axis wherein each received bid is plotted as a point on the graph, with each bid being color coded to associate it with a specific bidder. One axis corresponds to a composite score (the characteristics of which are specified by the auction organizer) and the other axis to price. The seller may be able to select points on the graph to receive information regarding the specific bid it represents. This is useful because it provides the seller with easy-to-understand real-time information regarding an ongoing auction, allowing for the seller to act accordingly to maximize profits by ending the auction early, inviting more bidders etc.

In other embodiments, the internal auction application may include functionality wherein the seller requests bids from potential bidders and receives information regarding the previous performance of the potential bidders in previous auctions. The novel aspect of this patent is that the system provides bidder information to the seller. This bidder information includes performance alerts associated with each of the bidders, these performance alerts indicate unsatisfactory performance or negative reviews. The seller is also provided with the identity of other sellers in previous auctions who associated the performance alert with each bidder, along with the total number of performance alerts filed by the seller in previous auctions. This system is useful because it makes selling items in an online auction more efficient as sellers are able to rank bids both on bid value and previous bidder performance, resulting in a decreased likelihood of selling to a bidder with undesirable qualities.

F—Business System Integration

Continuing from Section IV A, exemplary embodiments of the system with an internal auction application may include functionality wherein the internal auction application is integrated with an entity's business information system.

In exemplary embodiments, the internal auction application may incorporate functionality which includes having the system owner's inventory management system as a subsection of the auction application itself, rather than being integrated as two separate systems. Further, this functionality may include having the inventory management system of the business being based on inventory information which on previously sold items rather than currently held items.

In exemplary embodiments, the internal auction application may incorporate functionality which analyzes seasonality in inventory and provides a timeframe for the best time to auction a certain item. Further this may be communicated to the seller of the item prior to them listing it for auction (i.e. telling the customer that the best price for their car will likely be in December rather than in August).

In other embodiments, the internal auction application may include functionality wherein an electronic catalog of items for sale into an is converted into an auction. This functionality may take a business' online catalog, and with input from the business, automatically puts some of these items up for online auction through an exchange server. This functionality may include receiving, at an exchange server, catalog items previously for sale at catalog prices, wherein the items selected are based on one or more factors. This is useful because it combines the benefits of catalog-based selling with auction-based selling. Businesses often need a catalogue at fixed prices so consumers can know their large range of goods, but by combining this with an auction system the seller may increase revenue for items for which the fixed price was too low.

In other embodiments, the internal auction application may include functionality wherein each time a user logs into the auction application, the auction application automatically queries an internal inventory management system, transmits, and receives from the user listing criteria for the items available for auction, and reserves within the internal inventory management system the quantity of products available for auction in order to prevent the disposal of these items.

In other embodiments, the internal auction application may include functionality where the auction application is integrated with a business management system and may include a process which can be used when an error occurs in a forward-only computer process within the auction application. This may include defining certain milestones within a forward-only process where each milestone is a point that transaction state information is saved and the functionality may include saving entries and responses made by the user at each milestone, and in the event of a failure in a forward only process, rolls back the process to the milestone closest to where the failure occurred. This is useful because it prevents catastrophic errors from occurring i.e. listing a product for 1 cent and it streamlines the administration process of the auction as the administrator does not have to repeat a whole forward-only process in the event of an error.

In other embodiments, the internal auction application may include functionality which publishes scheduled auctions on a business' e-commerce site, where this auction application is integrated with the business' internal business information system. This functionality may include a method where after the end of a scheduled auction, the system evaluates whether or not the auction ended with a winning bid. If the auction ended with a winning bid, it may place an appropriate amount of inventory within the internal business management system on hold, then automatically create a new auction with the remaining inventory and a higher start price than the original. If the auction ended without a winning bid, the system may automatically create a direct product sales entry in the business' internal information system and publish a listing for direct sale of previously auctioned product. This is useful because scheduling auctions allows the seller greater flexibility in auctioning goods (i.e. if the seller has customers in China, scheduling the auction appropriate to that time zone when the seller is not at their terminal). The aspect of integration with a business' internal information system also helps to reduce cost and increase efficiency for a business.

In other embodiments, the internal auction application may include functionality wherein the auction application can create and publish auctions on a business' e-commerce site, where this auction application is integrated with the business' internal business information system, and the products for auction are automatically selected from business' internal information system catalogue. This may include a system by which items in a business' online catalogue are automatically put up for auction. The auction application may receive product parameters from the business information system, generate an auction based on these default parameters, and then allow the seller to modify the auction parameters and add additional products to the listing. This is useful because automatically converting a product catalogue to a set of auctions decreases overhead costs for a business and may result in increased revenue by selling their products in an auction style rather than at a fixed price in a catalogue.

In other embodiments, the internal auction application may include functionality wherein the auction application may automatically execute a login script of the user (a business) where this script includes a query to the user's business information management system containing user-specified listing criteria for products to sell and transmitting to the user what inventory in their database system meets their criteria. The auction application may then list the appropriate products onto an online auction service. This is helpful because it reduces cost to the supplier to put large amounts of items up for auction by making the process automatic instead of the supplier manually doing this process themselves.

In other embodiments, the internal auction application may include functionality wherein items in a business' inventory management system can be automatically listed for auction on the auction application. This may include searching a product inventory database for products that meet an age criterion, then automatically generating auction listing information for these products (which can be revised via a user interface), automatically listing these items on the auction application, and performing operations within the inventory management database once a sale has occurred. This is useful because it provides businesses with an efficient way of removing unwanted inventory, and by integrating with the business' internal database systems, reduces cost for the sale for these items.

In other embodiments, the internal auction application may include functionality with the graphical user interface with which an administrative user manages auctions. The auction application may be integrated with a business' customer relationship management (CRM) backend system. This may include functionality where once the user logs into the auction application, the system automatically transmits the login query to the CRM backend system to retrieve information about user-specified listing criteria, and then provides the user with products contained within the business' database which meet these criteria. This is useful because it reduces the cost of administrating a business' auction system by making it easier to administrate.

In other embodiments, the internal auction application may incorporate functionality which includes the creation of auction templates in internal auction application. This internal auction application may be integrated with a business' internal inventory database system. This may include the seller using the internal auction application to initiate an auction template creation process where this internal auction application is integrated with a seller business' information management system that manages retail sale of products, allows the user to select a product from the internal information management system to associate with the auction template, and creates an auction from this template with the associated item linked to the internal information management system. This allows for easier management of a business' internal auction system and thus reduces administrative cost for the business.

G—In-Person Integration

Continuing from Section IV A, exemplary embodiments of the system with an internal auction application may include functionality wherein the internal auction application is integrated with a physical in-person auction.

In exemplary embodiments, the internal auction application may incorporate functionality where a live auctioneer conducts a video and audio-based auction over a video streaming apparatus, where both the in-person and remote bidders are participating in the auction via a separate online-only auction application. The in-person bidders may access this application through smartphones or other devices.

In exemplary embodiments, the internal auction application may incorporate functionality which alerts users of the auction application than an in-person auction will be held in a place geographically close to them. This may be done by having users input their geographic location during user sign-up and giving them an alert that an in-person auction will be occurring, for example, 25 miles from them in a week. Further, the functionality may include alerting users that a vehicle which will be put up for auction is geographically close to them and providing them a timeframe and location where they can physically view the car prior to auction.

In other embodiments, the internal auction application may incorporate functionality which comprises a computer at the on-site auction transmitting and receiving information regarding the bid status of an auctioned item. The computer may process both remote bids from the auction application in addition to on-site bids. The on-site auctioneer may use the computer to select the winning bid, and this information is transmitted to the remote bidders via the auction application. This may include functionality wherein the computer chooses as the starting bid for the live auction the highest bid from the received remote bids. This is useful because it allows easy and streamlined access of an otherwise inaccessible auction to remote bidders.

In other embodiments, the internal auction application may incorporate functionality which includes integration of online bidders into a live in-person auction, wherein both live and remote bidders can participate in the auction. The functionality may include a pre-auction absentee bidding process in the auction application, wherein the application determines the highest absentee bid, and the auction begins accepting bids from both in-person and remote bidders with the highest absentee bid during the pre-auction process being the starting bid.

In other embodiments, the internal auction application may incorporate functionality wherein a recording medium (such as an IC or RFID tag) for storing information about the auctioned item may be attached to the auction item itself. Bidders may use mobile data devices to connect with the recording medium to place bids and retrieve information regarding the item. The auction application may run the auction itself, determining winners and other such auction management functions.

In other embodiments, the internal auction application may incorporate functionality with the interaction of remote participants in an on-site live auction. This may include a seller, located remotely, using the auction application, and allowing for this seller to monitor the auction and communicate with the live auctioneer. Remote bidders may also participate through the auction application. The remote seller may be able to indicate to the auctioneer to accept the highest bid or submit a counteroffer. This may also include functionality where the remote seller can propose a counteroffer, and the auction application may determine if the high bidder is in person or remote, and routes the counteroffer appropriately, either to a remote bidder via the auction application, or to the communication device used by the auctioneer in the case of an in-person highest bidder. This is useful because it allows sellers to participate, and have direct control over, auctions which would otherwise be inaccessible to them.

In other embodiments, the internal auction application may incorporate functionality which includes streaming the auction through the auction application with audio and video. The live auctioneer may be in person and may rely on electronic clerk and bid systems within the auction application to receive remote bids from bidders receiving streamed audio and video. The clerk and bid systems may be event-only driven with these non-time-based events occurring under the direction of the auctioneer. The auctioneer may be in full control of the auction, with the bid and clerk systems not under the control of time-based events i.e. the auctioneer can stop the auction when a desired bid level is acquired not when the auction is timed, and time runs out.

In other embodiments, the internal auction application may incorporate functionality by which remote bidders can participate in an in-person auction through audio and video streaming through the auction application. A live auctioneer may control the auction, an electronic clerk system may control both the live and remote bid handling, and an electronic marquee system may display instantaneous bid information throughout the auction. The auction may have in-person participants and remote participants who steam audio and video of the auction. The auction application's handling of the steaming may include maintaining a video delay of approximately one second or less, lowering the audio quality if necessary to ensure this, and if necessary, reducing the audio if it interferes with the bid status information. This is beneficial as remote clients with audio and video are more likely to feel the “excitement” of the auction and thus bid more.

H—Multiple Auction Formats and Phases

Continuing from Section IV A, exemplary embodiments of the system with an internal auction application may include functionality wherein the internal auction application creates and manages auctions, the format of which may have multiple formats and phases.

In exemplary embodiments, the internal auction application may incorporate functionality which utilizes a database of historical auction data to determine when to switch between auction styles. Further, an analytical program may be used to determine, from historical auction data, when to switch from one auction format to another based-on price, timing, etc.

In exemplary embodiments, the internal auction application may incorporate functionality which includes discriminating users into two groups where only one group can participate in the first round of the auction (i.e. car dealerships) and then opening up bidding to the other group in a second phase (ii. consumers) dependent upon certain factors, where each phase has different auction functionality or format. Further, this functionality may include a negotiation phase which may occur following a first general bidding phase where only a subset of bidders are allowed to participate.

In other embodiments, the internal auction application may incorporate functionality to allow for various online auction systems (reverse, forward, increasing price, decreasing price etc.) where the chosen format may have two or more rounds in the same auction. This may include determining participation of bidders based on the first round of the auction, and then using this information, applying a rule to the second auction, wherein the participation of bidders is limited. A particular embodiment of this may be that winners of the first auction are not able to participate in the second. This may be useful in that it may allow smaller buyers to participate, rather than one larger buyer dominating every round, so as to maintain a diversified customer base.

In other embodiments, the internal auction application may incorporate functionality to allow for reverse auctions (one buyer, many sellers) to be conducted. This may include, prior to the auction, a description for an acceptable system for purchase to be forwarded to the venders who will participate in the auction. Each vender then may send back a proposal to the purchaser. After this occurs, one-on-one negotiations between the purchaser and each of the venders may be conducted to ensure uniformity in proposals, these negotiations including adjusting components, services, or costs of the vender's proposed system. Also, an increment negotiation process may be conducted between the purchaser and each of the venders to determine an appropriate bid de-increment amount to be used in auction, wherein determinations are made as to how the systems offered will change based on bid de-increments. All of this may occur before the auction is conducted. This is useful because uniformity in system proposals in a reverse auction increases efficiency for both the buyer and seller in the acceptance of a systems contract. It also allows for the buyer to better discriminate between offers made by vendors.

In other embodiments, the internal auction application may incorporate functionality wherein two different types of auction formats may be used in sequence. This may include implementing at first a clock-based auction, where bids are transparent, before switching to a proxy auction where bids are concealed. The may further include, during the implementation of the first auction format, after each bid is received, the determining whether to continue with this format. Then, after this determination is made based on received bids, implementing the second auction format. This is useful because it combines the benefits of two auction formats.

In other embodiments, the internal auction application may incorporate functionality for combining two different auction formats in succession. This may include each auction format having its own bid-type. This may further include functionality wherein the first auction format bids are stored in a ranked set corresponding to the ranking of bid position, and the second auction bids are assigned a ranking based on a certain profit measure. By structuring an auction in this way, the auction host has more flexibility in determining the auction format to best fit their needs.

In other embodiments, the internal auction application may incorporate functionality which combines a Dutch auction format (high asking price decreasing until someone buys) in a first phase, with an English auction format (low asking price increasing until the highest bid is reached) in a second phase. This functionality may further include sending auction rules to participants explaining that in the first Dutch phase of the auction the winning bidder will not be awarded the item for auction, but in the second English phase of the auction the winning bidder will receive the item. The auction application may then conduct the first phase of auction, decreasing from a high starting seed price until someone bids, and then use this first bid price as the starting price for the second, English auction phase. This is useful because it better gauges the participating bidders' maximized price better than an English or Dutch auction alone.

In other embodiments, the internal auction application may incorporate functionality to allow the implementation of an auction phase and a negotiation phase. This negotiation phase may be reached if a time-trigger is met, and the reserve price was not reached during the auction phase. This negotiation phase includes extending the auction with buyers selected from a predetermined panel of buyers, requesting, and receiving a bill of materials from multiple buyers, establishing a rating for each buyer, applying this rating to further offers from the buyers, and finally providing each buyer with a current bid to win (CBTW). This is beneficial as it helps to maintain buyer-supplier relations and prevents buyers from seeking out other sellers if the reserve price for the initial auction is not met.

In other embodiments, the internal auction application may incorporate functionality for conducting online reverse auctions (online auctions where a plurality of supplies bid to a single buyer). This may include the auction application creating a RFQ (request for quotation) “object” (object being electronic, not physical) for the buyer on the auction application representing an opportunity for suppliers to supply. This RQF may then receive quotations from suppliers for whatever the buyer is trying to buy. In addition, the implementation may allow for quotations to be determined unsatisfactory, and in response, the RQF object may be converted into a reverse-auction object and a reverse auction may be started. This is helpful because if the buyer is not receiving the quotations they desire, an auction system may help to drive down the price.

In other embodiments, the internal auction application may incorporate functionality for auctioning lots of items in a series of auctions. This may include dynamically pricing the subsequent auctions following the first, as opposed to a solely increasing/decreasing price-based auction. The functionality may further include setting the second auction's starting price by combining a spread factor (determined from bids received in the first auction) with the outcome of the first auction. Further, this functionality may adjust the price of the second auction as the auction is ongoing based upon data from the first auction. This dynamic pricing system is useful as it better able to reflect market conditions, making the auction system more efficient for both the bidder and seller.

I—Novel Auction Formats

Continuing from Section IV A, exemplary embodiments of the system with an internal auction application may include functionality wherein the internal auction application creates and manages auctions, the format of which may be novel.

In exemplary embodiments, the internal auction application may incorporate functionality which includes geographically based online auctions wherein the remote bidders are ranked in part by how far they are from the product for auction.

In exemplary embodiments, the internal auction application may incorporate functionality which includes continuous double auctions where the trading occurs specifically between car dealerships and individual car sellers for vehicles specifically. Further, this functionality may include a system of matching buyers and sellers where data analytics are utilized, which are based on the historical preferences of all parties.

In other embodiments, the internal auction application may incorporate functionality determining the social connections between the buyer and seller in an online auction, and with this information, the functionality may determine both the type of auction format and the ability of a bidder to bid in this auction. Further, this functionality by incorporate allowing or denying a bidder to participate in a selected auction method based on the social value determined representing the relationship between bidder and seller. This is preferable to previous forms of online auctioning because it reduces the risk of fraud because individuals with close social relationships are less likely to defraud each other.

In other embodiments, the internal auction application may incorporate functionality wherein continuous double auctions for a plurality of heterogenous items are performed. Continuous double auctions (CDAs) are typically used solely in the exchange of commodities rather than heterogenous goods. CDAs are a system where bids (offers to buy at a certain price) and asks (offers to sell at a specific price) are conducted simultaneously during a trading window. This functionality may apply the CDA system to heterogenous goods. The functionality may further include a bid set with a contingent first bid on a first of a plurality of heterogenous items, and a second contingent bid on a first of a plurality of heterogenous items. The auction may be ended when the first contingent bid is recognized as the winning bid. Simultaneously, the second contingent bid may be withdrawn as a remaining bid in the bid set. The bid set may be visible to both sellers and buyers participating in the CDA system. This is useful as it provides more transparency than other auction formats and is a fairer system than other auction formats.

In other embodiments, the internal auction application may incorporate functionality to perform a modified Dutch-Auction format auction (where a high price for a good is initially set and negotiated down). This functionality may be based around “value points” which are used in bidding and have a currency exchange rate. The seller and auction application owner make money not just on the sale of the good at auction, but also the price differential between value points and currency. Further the functionality may consider user specific information during the bidding. Bidders may bid using value points, bids may be accepted if the user has enough value points in their account to make the bid and bidders may be notified if they do not have enough value points to place the bid. Value points may be deducted from the bidder's account each time they make an accepted bid but are replenished at the end of the auction if they are not the winning bidder and are not replenished if they are the winning bidder. This is useful because it considers the interests of three parties: the seller benefiting from their portion of “value point”—currency differential and the sale of the item, the auction commission from their portion of “value point”—currency differential, and the buyer from buying a good at a low price.

J—Winning Allocation

Continuing from Section IV A, exemplary embodiments of the system with an internal auction application may include functionality wherein the internal auction application allocates the items for auction to buyers in different ways.

In exemplary embodiments, the internal auction application may incorporate functionality which discriminates amongst the highest bidders in an auction, which may have all bid the same or similar amounts and awarding the item to this bidder based on the bidder's performance in historical auctions (ii. this dealership has not won an auction in a long time, so their bid would be prioritized over that of others).

In exemplary embodiments, the internal auction application may incorporate functionality wherein vehicles are auctioned in lots where winning allocation is done in by considering geographic factors, the historical preferences of dealerships involved etc. I.e. if a lot of 10 Toyotas were put up for auction, preferring to allocate to Toyota dealerships specifically could be helpful, or preferentially allocating to buyers within a certain geographic region.

In other embodiments, the internal auction application may incorporate functionality wherein a plurality of items of the same type are being auctioned. This functionality may include a reward system, wherein a “reward” may be a certain number of the items for sale and may be given during the auction to bidders to incentivize further bidding. Further, this functionality may include a formula for allocating the award amongst at least the first and second ranked bidders, wherein the bid differential may be used to calculate the allocation of the award. The portion of the award to the higher bidder may increase as the magnitude of the bid differential between the top buyers increases. This formula and system are intended to incentivize competition between bidders for the seller's benefit.

In other embodiments, the internal auction application may incorporate functionality which distributes a portion of auctioned goods to both the first and second highest bidders. Prior to auction, a maximum and minimum volume to be awarded during the auction may be determined. Further, the functionality may include, following the conclusion of the auction, the highest bidder being awarded a number of items equal to the minimum volume plus an additional volume, up to the maximum volume. This amount may be based on a factor that is related to a difference between the first and second ranked bids. The second highest bidder may also be awarded a portion of the total volume. This is advantageous because in a multi-round auction it provides an incentive for competitive bidding if the next round contains complementary goods. It also prevents a sole buyer from dominating an auction, leaving all other bidders with nothing, which leads to increased bidder satisfaction and thus further participation.

In other embodiments, the internal auction application may incorporate functionality wherein the lowest and unique bid wins the auction, as opposed to the highest bid. Profits for the seller may not come from the price of the item itself, but rather from collecting fees from bidders each time they place bids for the lowest bid. However, the lowest bid winning the auction may not always be the case. In the event that there exists no lowest and unique bid, the auction application may determine the bidder who has bid the greatest number of times in the auction and may sell the item to this bidder at the highest bid this bidder placed, as determined by their bidding history.

In other embodiments, the internal auction application may incorporate functionality wherein a portion of one of the non-winning bids in an auction is distributed to one or more non-winning bidders in the auction. The functionality may include a provision wherein each non-winning bid amount is paid by the bidder to the seller ii. placing a bid means paying the seller that amount regardless of winning the item. Further, the functionality may include only the winning bid being paid to the seller by the winning bidder and non-winning bids may not transacted. Further, this functionality may include the determination of a “second bid.” This second bid may be determined to be a bid placed after the first bid in the auction, which exceeds the first bid amount. This determination of marking a bid as a “second bid” (which may not actually be the second bid chronologically in the auction) may also be based on a time increment after the first bid is submitted. Then, at auction close, the auction application may determine, based on the value of the second bid, a portion of this bid for distribution to one or more non-winning bidders. This is useful because it provides non-winning bidders with positive reinforcement for participating in the auction, leading to greater bidder participation in the future and decreasing non-winning bidder dissatisfaction.

In other embodiments, the internal auction application may incorporate functionality wherein a plurality of like goods are sold, where the auction application seeks to determine the market equilibrium price of each unit of goods through the auction process itself. The auction application may have each participant submit a budget account limit prior to auction. Then during the auction, the seller may sell units of goods to the highest bidder until this bidder's budget is exhausted, debiting this bidder's account. Then, the seller may lower the price of the remaining goods. When a second bidder buys goods at this price, the seller may credit the first bidder's account the difference in first and second prices for each unit the first bidder bought. Further, the functionality might be such that the bidders who bought at the first or second price are given priority over the other plurality of bidders in acquiring more units for at least a portion of the remaining units. This is useful first, because this functionality can be repeated recursively a number of times until each bidder pays the same price per unit of good, measuring the true market equilibrium price of the good. Second, because it reduces the likelihood of bidders becoming dissatisfied with the auction host because they are constantly being outbid by a larger buyer.

In other embodiments, the internal auction application may incorporate functionality by which coupons are incorporated into online auctions in such a way that coupon-holders are not given an advantage over non-coupon holders. This allows for goods to be sold in online auctions at fair market price. Further, this functionality may determine the winner of the auction by identifying and sorting bidders into coupon-holding and non-coupon-holding collections, and then determining the winner of the auction as the highest bidder in either collection of bidders through a randomization technique.

In other embodiments, the internal auction application may incorporate functionality wherein a plurality of products each with specific quantities greater than one are auctioned. This functionality may include dividing the quantity of an item into two sub-lots (the combination of sub-lots equaling the total quantity of the item), the auction application may then auction these sub-lots separately and determine the winning bids based on the highest combination of bids for the sub-lots. This is beneficial because if there is a multitude of items for sale and bidders bid only on certain portions of each lot, dividing into sub-lots the quantity of each item allows for increased bidder participation.

In other embodiments, the internal auction application may incorporate functionality wherein items are sold in lots and bids may be received for portions of said lots or for the whole lot itself. The auction application may use software to determine from plural combinations of bids the optimal bid combination by maximizing a function which process the statistical calculation of which combination is optimal. This is valuable because it allows the auction to operation more efficiently, increasing the total dollar amount received by the auctioneer while efficiently allocating items to the bidders which value them the most.

In other embodiments, the internal auction application may incorporate functionality to determine the optimal allocation of winning bids in a combinatorial auction. In a combinatorial auction, bids are placed on multiple lots of items, with each lot containing a plurality of similar type items. The bids submitted for these lots indicate both the quantity the bidder wishes to acquire along with the price at which the bidder is willing to acquire them. In a large combinatorial auction, determining the optimal allocation of winning bids is difficult because (for example) the bids for a particular lot may exceed the total number of items for sale in this lot, with each bid price being different. The functionality may store the bids received in a search tree (a computer science object for efficiently storing and searching for data), with the nodes of the tree being the bids received. The auction application may then traverse this search tree to find the optimal bid combination which best allocates the items at auction to bidders. This is useful because it maximizes profit to the seller while using an efficient amount of computational resources.

K—Auction Result Prediction

Continuing from Section IV A, exemplary embodiments of the system with an internal auction application may include functionality wherein the internal auction application may estimate the result of an auction.

In exemplary embodiments, the internal auction application may incorporate functionality wherein auction prediction algorithms may be used, the resulting price determined, and may then communicated to select customers as a fixed price. This price may be communicated as the predicted auction result to a customer and be decreased by a certain amount in order to achieve a quick sale.

In exemplary embodiments, the internal auction application may incorporate functionality which includes an auction prediction algorithm which utilizes an internal database of historical auction information, in addition to data scaping external websites. The spread of possible prices may then be communicated to sellers or the system owner.

In other embodiments, the internal auction application may incorporate functionality to predict auction results based upon auction and item characteristics. The auction application may then return the likely auction result. Further this functionality may predict auction results comprising multiple end-of-auction price thresholds (multiple possible sale prices), the confidences for each of these thresholds, and associated result indicators (sell or do not sell etc.). This provides the user with information to make more informed auction decisions.

In other embodiments, the internal auction application may incorporate functionality to use predicted auction results to determine insurance pricing for an item for sale in an auction. Further this functionality may predict the results of an auction to obtain the insured auction result and may use this to determine the insurance cost for an item in an auction. This functionality may be in the form of auction prediction application integrated with an insurance cost prediction application in order to be able to provide information for auction result insurance. Further, the functionality may include the auction application using a processor to pass a predicted auction result to an insurance parameter determination program in order to obtain an insured auction result and determine an insurance cost for the auction.

In other embodiments, the internal auction application may incorporate functionality to utilize information gathered about an auction entity (seller or buyer) and use computer functions to analyze this data to estimate preference policies of this entity. For example, the US government has a 50% price preference for American made goods, frequent bidders may have more elastic preferences etc. Further, this functionality may use these preferences to predict the outcome of an auction from a group of candidate preference policies, wherein these policies treat bidders differently, and may then determine the policy preference optimal for conducting an auction prior to the auction beginning. This is preferable to alternatives because it optimizes the efficiency of an online auction.

L—Bidder Systems

Continuing from Section IV A, exemplary embodiments of the system with an internal auction application may include functionality wherein the internal auction application may utilize systems to connect bidders to a multitude of auctions.

In exemplary embodiments, the internal auction application may incorporate functionality which includes the integration of analytic systems which optimize a bid amount and present this to the seller with the auction host system.

In exemplary embodiments, the internal auction application may incorporate functionality which includes allowing bidders on the internal auction application to choose between different automatic, analytical bidding models as an alternative to placing a proxy bid. Further, this functionality may be monetized where car dealerships could purchase the option to use these bidding models for each auction. I.e. if a dealership wants an increased chance of winning preferred cars, they could pay $X to the system owner to increase their chances by using a built-in bidding model.

In exemplary embodiments, the internal auction application may incorporate functionality which includes aggregating and presenting to the bidder previous, or ongoing online auctions of a similar type and presenting this information to a bidder within the auction application.

In other embodiments, the internal auction application may incorporate functionality for use by bidders in online auctions to optimize bidding amongst a plurality of items. This functionality may calculate an optimized utility of bidding by the buyer on multiple items based on internal calculations of risk and optimization. The auction application may further rank bid amounts by optimal auction outcomes for the bidder. In addition, this functionality may estimate the ranking of a bid amounts for first and second items and compare the estimated incremental effects between the two items in terms of ranking. The auction application may then submit the optimal bid amounts to the operator of the auction. This allows the bidder greater efficiency in bidding simultaneously in multiple online auctions.

In other embodiments, the internal auction application may incorporate functionality for automated bidding for bidders. This bidding automation may be incorporated in the auction application, which then may pull from the internet auctions which the bidder may be interested in. These auctions may or may not be hosted on the auction application or managed by the system owner. This automated bidding functionality may scan a selected auction within a time of auction closing window (TACW), where this window is determined by a plethora of variables including current bid, relative differential bid value, auction service host performance parameters etc. This seeks to address the problem of bidders having to constantly monitor a multitude of auctions and be physically present at a computer terminal at time of auction close.

In other embodiments, the internal auction application may incorporate functionality to determine the optimal bid to place in an online auction. This may include the auction application calculating, based on certain parameters, the most optimal bid for a bidder to place and then submitting this estimation to the bidder. Further, this functionality may use information about the characteristics of the market in question, user-specific auction evaluation criterion, and may select a bidding model based on these characteristics. In addition, it the auction application may determine a bid function based on the structure of the market, user inputs on the item being auctioned, and characteristics of rival bidders. This bid function may be used to provide an optimal bid estimate. This is useful as an accurate optimal bid estimation both increases the chances of the bidder winning the auction and also prevents the bidder from overbidding.

In other embodiments, the internal auction application may incorporate functionality to automatically conduct reverse auctions (a buyer soliciting quotes from a plurality of sellers, seeking the lowest quote) without any manual intervention during the auction itself. This may involve the auction application automatically searching for and soliciting offers from a plurality of potential suppliers, on behalf of a buyer, all without the buyer having any manual interaction in the auction process. Further, this functionality may contain a feedback-driven, closed-loop adaptive and real-time time-iterative computational engine. This may allow the auction application to automatically adapt to price quotations by sellers and provide appropriate changes in the auction to better these quotations while staying in line with a predetermined strategy without requiring any manual intervention. This is helpful because full automation reduces human error in running auctions, and this tool provides the average consumer with the ability to solicit offers from potentially thousands of suppliers, rather than manually searching the internet for the lowest price for a given good.

In other embodiments, the internal auction application may incorporate functionality where users of the application are able to search for, and participate in, a multitude of online auctions occurring on different online auction sites. This functionality may include the auction application maintaining a keyword database where each keyword is associated with a particular item for auction at an auction site and users may be able to search for relevant auctions using this keyword. Upon this keyword search, the auction application may provide static and dynamic information regarding the items for auction and a portion of this information may be activated by the user to redirect them to the auction host site for a particular item. This is useful because it can be used by sellers to obtain access more easily to sites and auctions than manually searching through the internet, and it can be used by sellers to determine which sites are best suited to auctioning their specific good.

M—Financial Functionality

Continuing from Section IV A, exemplary embodiments of the system with an internal auction application may include functionality wherein the internal auction application may be used for the auction of financial instruments and may be incorporated with systems for financial transactions.

In exemplary embodiments, the internal auction application may incorporate functionality which includes auctioning a percentage of equity in an item for auction, where bidding occurs on percentage increments, and winning bidders are awarded the final share price of the item after it is sold. This functionality may be only provided in a situation where a dealer has bought a vehicle, but wants to mitigate their risk in selling it, so they maintain (for example) 70% ownership in the car and auction off the remaining 30% ownership. The dealer would then sell the car, and the other equity holders would be awarded their proportional amount of the final sale price. Furthermore, this may be an option provided to a dealership automatically after a dealership buys a car using the standard auction process.

In exemplary embodiments, the internal auction application may incorporate functionality which includes a simulated auction which may only include car dealerships, wherein the purpose of the simulation is to gauge the market value of a specific vehicle.

In other embodiments, the internal auction application may incorporate functionality wherein goods are elevated at their VWAP (Volume Weighted Average Price), which is a benchmark used by brokers and other traders of commodities/financial instruments. This functionality may allow for timed auctions wherein bidders may bid on volume orders priced at VWAP with a price increment. This functionality may allow bidders to be able to submit bids to buy or sell at VWAP offset by a price increment, wherein the VWAP is determined in the auction application by collected trade prices/sizes, and the collected trade prices/sizes at which VWAP orders are matched. The auction application may include matching orders in an online auction such that a of the plurality of orders in the auction, a portion are matched, and a portion are unmatched. The auction application may then cancel the unmatched orders, and the matched orders may be filled based at least in part on the determined VWAP price. This is useful because it consolidates pricing at the VWAP and trading at this price into one system.

In other embodiments, the internal auction application may incorporate functionality used for trading financial securities or derivatives. The auction application may manage an electronic trading engine to receive requests to internally trade securities or derivatives between financial institutions. Based upon information within the request, an electronic trading engine may disseminate a request for price to at least one user. The engine may then select an allocation algorithm representative of an auction type. The engine may then initiate an auction based on this request for a predetermined amount of time. This functionality may include the step of, after receiving the price request from the user, the trading engine does not disseminate this information to an external reporting entity or exchange. This is beneficial because it allows for easier and more efficient internalized trading of securities and derivatives between entities without the drawbacks of physical open outcry exchanges.

In other embodiments, the internal auction application may incorporate functionality for having user accounts which contain a certain amount of money in a similar fashion to a bank. The auction application may compare the final bid amount of an auction to a pre-determined threshold amount and uses this information to determine the preferred payment process. This process may include debiting the buyer's selected account for the final bid amount, holding this amount in escrow, and then settling the amount in seller's account located within the auction application. Both buyer and seller may have accounts capable of holding currency within the auction application. This is an improvement over previous online auction methods because it decreases fraud.

In other embodiments, the internal auction application may incorporate functionality for a simulated online auction for the purpose of establishing a market price for a financial security or other item. This functionality may include a simulated auction with fees attached to placing simulated bids to attempt to gauge market information, and then sharing this acquired market information with selected participants. This functionality may be utilized for collaborative development to obtain price forecasting information to guide bidders in a future market auction. The functionality may also include a rewards module which dictates what information gets shared to which participants in the simulated auction based on their utility in said simulated auction. This is useful because it provides a more efficient method of pricing financial instruments or determining the market price of other items.

In other embodiments, the internal auction application may incorporate functionality wherein the goods transacted are “risks” associated with financial instruments. The functionality may include receiving bids to assume a portion of risk, and the bidding may be based on the yield required on this risk, and the auction application rules and procedures are applicable to a relevant category of risk transactions. This is preferable to alternatives as it increases transparency in the exposure market, better allowing buyers and sellers to make transactions based on current market conditions.

In other embodiments, the internal auction application may incorporate functionality wherein the mutual exchange of financial securities and cash is transacted. This may be in the form of an auction application wherein the auction host (central counterparty) assumes the credit risk usually assumed by a broker in traditional non-auction securities exchange. The auction application may utilize quantities of securities exchanged and a corresponding transaction fee. This fee is intended to replace the traditional broker fee (based on the spread of cash and interest paid) because it is the auction host assuming the credit risk for the exchange of securities. This is preferable because it gives greater transparency to both the lender and borrower of securities and efficiently replaces a broker in these transactions.

What is claimed is:

1. A processor-based platform usable with an external database and having at least one memory with an internal database and computer readable code stored thereon that enables a user of the platform to facilitate sale of a specified object, the internal database having data relating to sale of a plurality of internal objects via the platform, some of the plurality of internal objects sharing characteristics similar to the specified object, the external database having data relating to sale of a plurality of external objects via the platform, some of the plurality of external objects sharing characteristics similar to the specified object, the code enabling steps comprising:
enabling a user to input data relevant to characteristics of the specified object that are relevant to value of the specified object;
calculating three different price ranges for the specified object based on the input data, the step of calculating including:
analyzing the internal database based on the input data to identify other similar internal objects that share similar characteristics to the specified object,
storing as a first data set data relating to the identified similar internal objects including data relating to sale, market trends, seasonality, and geographic location,
analyzing the external database based on the input data to identify other similar external objects that share similar characteristics to the specified object,
storing as a second data set data relating to sale of the identified similar external objects, and
utilizing the first and second data sets to generate three ranges of pricing relevant to the specified object, where the three ranges differ based on time dependent variables relating to length of time for completing sale of the specified object, such that shorter sales times provide relatively low price ranges compared to longer sales times, the three ranges include a low price range, a medium price range, and a high price range;
providing the user with three different choices for selling the object, the three choices including:
a first choice for the user to complete sale of the specified object over a short period, the first choice providing the user with the generated low price range,
a second choice for the user to complete sale of the specified object over a second period longer than the short period, the second choice providing the user with the generated medium price range, and
a third choice for the user to complete sale of the specified object over a third period longer than the second period, the third choice providing the user with the generated high price range; and
enabling the user to select one of the three choices to thereby facilitate sale of the specified object.

2. The processor-based platform of claim 1, further comprising an internal auction application that enables a user to:
list the specified object on an online auction,
host the online auction by managing auction format, bidding functionality, auction pacing, and proxy bidding,
electronically exchange currency between users upon termination of the online auction, and
electronically exchange ownership rights of the specified object upon termination of the online auction.

3. The processor-based platform of claim 2, wherein the internal auction application is hosted on a separate subsidiary platform separate from the at least one memory, the internal database, and the computer readable code stored thereon, to thereby enable uses to buy the specified object on the subsidiary platform, the subsidiary platform being able to communicate with the internal and external databases and the computer readable code stored thereon.

4. The processor-based platform of claim 2, wherein the code enables steps further comprising prompting the user to purchase a new object different from the specified object via the internal auction application, identifying potential new objects based on characteristics of the specified object, and presenting the identified potential new objects to the user.

5. The processor-based platform of claim 1, wherein the code enables steps further comprising prompting the user to purchase a new object different from the specified object, identifying potential new objects based on characteristics of the specified object, and presenting the identified potential new objects to the user.

6. The processor-based platform of claim 1, wherein the specified object is a vehicle.

7. The processor-based platform of claim 1, wherein the vehicle is at least one of an automobile or truck.

8. The processor-based platform of claim 6, wherein the vehicle is at least one of a boat, jet ski, and snowmobile.

9. The processor-based platform of claim 1, wherein the medium price range is generated based on an estimation of bidding results of multiple commercial entities engaged in selling objects similar to the specified object.

10. The processor-based platform of claim 9, wherein the commercial entities are entities that focus on selling automobiles.

11. The processor-based platform of claim 1, wherein the first choice presented to the user enables the user to directly sell the specified object to a dealer for the low price range, and the system facilitates the transfer of the specified object to the dealer by facilitating scheduling appointments and exchanging sales documents.

12. The processor-based platform of claim 11, wherein the code enables steps further comprising facilitating inspection of the specified object by a potential buyer, and prompting the user with choice 2 if the potential buyer rejects the specified object based on the inspection.

13. The processor-based platform of claim 1, wherein the second choice presented to the user enables the user to sell the specified object via auction of participating commercial entities engaged in selling objects similar to the specified object, and the system facilitates the transfer of the specified object by facilitating scheduling appointments and exchanging sales documents.

14. The processor-based platform of claim 13, wherein the code enables steps further comprising prompting the user with alternative selling options if the specified object is not sold at the auction.

15. The processor-based platform of claim 1, wherein the third choice presented to the user enables the user to sell the specified object via a commercial entity engaged in the business of selling objects similar to the specified object, wherein the sale to the commercial entity is completed upon the commercial entity receiving offers for the specified object from a third party.
